(19) United States
(12) Patent Application Publication
(10) Pub. No.: US 2006/0185190 A1
(43) Pub. Date: Aug. 24, 2006

(54) Method for operating an appliance comprising at least one drying cycle

(75) Inventors: Egbert Classen, Wertingen (DE); Helmut Jerg, Giengen (DE); Kai Paintner, Adelsried (DE)

Correspondence Address: JOHN T. WINBURN, 100 BOSCH BOULEVARD, NEW BERN, NC, 28562, US

(73) Assignee: BSH Bosch und Siemens Hausgerate, GmbH, Munich (DE)

(21) Appl. No.: 10/565,695

(22) PCT Filed: Jul. 6, 2004
(86) PCT No.: PCT/EP04/07393

§ 371 Date: Jan. 23, 2006

(30) Foreign Application Priority Data
Jul. 30, 2003 (DE) 10334794.1

(51) Int. Cl. F26B 3/00

(52) U.S. Cl. 34/471; 34/468; 34/470

(57) ABSTRACT

A method for operating an appliance includes at least one drying cycle, which makes it possible to operate appliances comprising at least one drying cycle as economically as possible while efficiently drying the material that is to be dried and keeping the energy consumption associated therewith as low as possible. Air contained in a processing space is conducted out of and back into the processing space during the drying cycle via a conduit system into which both ends of a heat tube protrude. The air is cooled while being directed through the conduit system such that humidity is removed therefrom, whereupon the air is heated again.

The invention relates to a method for operating an appliance comprising at least one sub-program step “drying”, such as is applied for example in laundry driers, dishwashers, crockery driers, shoe driers etc.

Various methods are known for drying, for example, items to be washed in a dishwasher. For example, the objects to be washed can be dried by own-heat drying if the rinsing liquid is heated in a partial program step “clear rinse” and thus the objects to be washed which have undergone a hot clear rinse are dried by themselves by the self-heat of the objects to be washed which has thus built up during the drying process. In order to achieve this own-heat drying, the rinsing liquid is heated to a certain temperature in the “clear rinse” partial program step and applied to the objects to be washed by means of spraying devices. As a result of the relatively high temperature of the rinsing liquid in the “clear rinse” partial program step of usually 65° C. to 75° C., it is achieved that a sufficiently large quantity of heat is transferred to the objects to be washed so that water adhering to said objects to be washed vaporises as a result of the heat stored in the objects to be washed.

In a further known method for drying items to be washed in dishwashers, a separate heat source, e.g. a hot air fan, is used to heat the moist air mixture during the drying process so that the air in the washing container can absorb a larger quantity of moisture.

Dishwashers are known in which the moist air is vented outwards. This is disadvantageous since the surrounding kitchen furniture is damaged.

Thus, other methods are known in which the moist air is passed over condensing surfaces on which the moisture condenses before being guided out. This condensation is either passed into the washing container or into special collecting containers.

A method of the type specified above for dishwashers is known from DE 27 16 686 A1 wherein a heat pipe protrudes in the washing container and forms a cooling surface there. The heat given off by the hot moist air is transported outwards by means of the heat pipe. In order that the heat pipe does not also remove heat during the partial program steps in which heating is desired in the washing container, in these partial program steps the heat pipe is filled with an inert gas which prevents the heat pipe from functioning.

A disadvantage in the heating systems described above according to the prior art described further above is that the heating of the rinsing liquid is associated with a high energy requirement and the thermal energy required for each heating phase must be produced anew by means of electrical heating elements. The known heating systems also have the disadvantage that the heating of the rinsing liquid in the “clear rinse” partial program step and the processes in the “drying” partial program step are themselves associated with a high energy requirement and the thermal energy required is lost after the drying process.

It is thus the object of the present invention to provide a method which can be used to operate appliances of the type specified initially as economically as possible, to efficiently dry the objects to be dried and to keep the related energy costs as low as possible.

This object is solved by the method according to the invention having the features according to claim 1. Advantageous further developments of the present invention are characterised in the dependent claims.

In the method according to the invention for operating an appliance comprising at least one sub-program step “drying”, during the at least one sub-program step “drying” air is conducted from a treatment chamber via a conduit system into which both ends of at least one heat pipe protrude and said air is then recirculated to this chamber, wherein during its passage through said conduit system the air is cooled, moisture is removed and the air is subsequently reheated.

As a result of using a heat pipe, the objects to be treated only require substantially less heating compared with the prior art, e.g. in dishwashers in the “clear rinse” partial program step. This means a substantial saving of energy. The cooling of the air lowers its moisture absorption capacity and the moisture fraction of the air is precipitated as condensate. As a result of the heating of the air, its moisture absorption capacity is increased again on each passage through the conduit system which leads to an improvement in the drying result and/or shortening of the drying time. In the closed air system any exchange of contaminated air from the surroundings is completely eliminated, preventing any back contamination of the items to be treated. The present invention provides a method which can be used to operate appliances of the type specified initially as economically as possible, to efficiently dry objects to be dried and to keep the associated energy expenditure as low as possible.

According to a preferred feature of the invention, air is conveyed by means of a fan, thereby facilitating control of the use of the heat pipe, e.g. compared with the method described in DE 27 16 686 A1.

According to another preferred feature of the invention, the air is cooled by means of the heat pipe. The actual function of a heat pipe, cooling whilst removing the absorbed thermal energy, is thus used according to the method according to the invention. The cooling of the air reduces its moisture absorption capacity and the moisture fraction of the air is precipitated as condensate.

According to another preferred feature of the invention, the air is heated by means of the heat pipe. The further function of the otherwise present heat pipe, the transported heat absorbed during cooling of the moist air and during condensation of the moisture from the air, is used for further energy saving.

According to an advantageous embodiment of the invention, the air is heated by means of a heater. Should the heating of the air by the heat pipe not be sufficient, the air is additionally heated by a heater to ensure the drying function. Despite the additional energy consumption for the heating, a saving of energy is achieved compared with the prior art described previously.

According to another advantageous embodiment of the invention, the air is passed by a condenser. Should the withdrawal of moisture from the air by the heat pipe not be sufficient, the air is additionally passed by a condenser which undertakes the lacking removal of moisture to ensure the drying function.

The invention is explained hereinafter with reference to an exemplary embodiment of a method in a dishwasher.

The method according to the invention for operating an appliance comprising at least one sub-program step “drying” is implemented in the exemplary embodiment explained in a dishwasher. It is known that a dishwasher has a washing method whose program run consists of at least one partial program step “pre-rinse”, a partial program step “clean”, at least one partial program step “intermediate rinse”, a partial program step “clear rinse” and a partial program step “dry”. According to the invention, in the exemplary embodiment explained during the at least one partial program step “dry”, air is conducted from a treatment chamber via a conduit system into which both ends of a heat pipe protrude and said air is then recirculated to this chamber, wherein during its passage through said conduit system the air is cooled, moisture is removed and the air is subsequently reheated.

In the exemplary embodiment the treatment compartment of the dishwasher, the washing container, is equipped with an outlet in the upper area of the washing container. From this outlet an air conduit leads to a fan and from the fan to the “cold side” of the heat pipe.

As is known, by means of a working fluid contained therein, a heat tube or “heat pipe” has the property of guiding heat at high speed and in a large quantity from one side—the so-called “cold side”—of the heat pipe to the other side—the so-called “warm side”—of the heat pipe. Thus, if the moist air is fed to the “cold side” of the heat pipe, this side cools the moist air and thus reduces the moisture absorption capacity of the moist air, causing the moisture contained in the moist air to condense. On the “cold side” of the heat pipe, said pipe thus extracts the heat (sensible heat) from the moist air and also absorbs the condensation heat produced (latent heat) and transports the heat to the other end—to the “warm side” of the heat pipe.

In the exemplary embodiment a further air conduit leads from the “cold side” of the heat pipe to the “warm side” of the heat pipe and from there to an inlet located in the lower area of the washing container.

If the air now reaches the “warm side” of the heat pipe, the air is now heated by said tube.

The heated air fed into the washing container is now substantially drier and thus again has a high absorption capacity for moisture. It rises upwards in the washing container and absorbs the residual moisture on the items to be treated, the objects to be washed. Said air is now fed back to the conduit system as described above.

As a result of using a heat pipe, substantially less heating of the objects to be treated is required compared with the prior art, in the exemplary embodiment described, only by about 50° C. or possibly even lower in the “clear rinse” partial program step in dishwashers. This means a substantial saving of energy. As a result of the cooling of the air, its moisture absorption capacity is reduced and the moisture fraction of the moist air is precipitated as condensate. As a result of the heating of the air, its moisture absorption capacity is increased again on each passage through the conduit system which results in an improvement of the drying result and/or shortening of the drying time. In the closed air system exchange of contaminated air from the environment is completely eliminated, preventing back contamination of the treated items.

Should the removal of moisture from the air as a result of the cooling by the heat pipe not be sufficient, the air is additionally passed by a condenser which undertakes the lacking removal of moisture to ensure the drying function. The condenser can be located in the direction of flow of the air before or after the “cold side” of the heat pipe, in the exemplary embodiment it is located after the “cold side” of the heat pipe.

Should the heating of the air by the heat pipe not be sufficient, the air is additionally heated using a heater to ensure the drying function. In the exemplary embodiment described the heater is located shortly before the inlet of the treated air into the washing container. Despite the additional energy consumption for the heating, a saving of energy is achieved compared with the previously described prior art.

The present invention provides a method which can be used to operate appliances of the type specified initially as economically as possible, to efficiently dry items to be dried and thus keep the associated energy expenditure as low as possible.

1-6. (canceled)

7. A method for operating an appliance, comprising:
subjecting items retained in the appliance to a drying step after the items have undergone a treatment step as a result of which moisture remains on the items, the step of drying including conducting air from a treatment chamber via a conduit system in which both ends of at least one heat pipe protrude, thereafter conducting the air through the at least one heat pipe, and recirculating the air back to the treatment chamber, whereupon, during the passage of the air between its exit of the treatment chamber and its recirculation to the treatment chamber, the air is cooled, moisture is removed from the air, and the air is subsequently reheated.

8. The method according to claim 7, wherein the air is conveyed by means of a fan.

9. The method according to claim 7, wherein the air is cooled by means of the heat pipe.

10. The method according to claim 7, wherein the air is heated by means of the heat pipe.

11. The method according to claim 7, wherein the air is heated by means of a heater.

12. The method according to claim 7, wherein the air is passed by a condenser.
